(19) United States
(12) Patent Application Publication
(10) Pub. No.: US 2022/0028141 A1
(43) Pub. Date: Jan. 27, 2022

(54) METHOD AND DEVICE OF DYNAMIC PROCESSING OF IMAGE AND COMPUTER-READABLE STORAGE MEDIUM

(71) Applicant: BOE Technology Group Co., Ltd., Beijing (CN)

(72) Inventors: Dan Zhu, Beijing (CN); Pablo Navarrete Michelini, Beijing (CN); Hanwen Liu, Beijing (CN)

(73) Assignee: BOE Technology Group Co., Ltd., Beijing (CN)

(21) Appl. No.: 17/296,773

(22) PCT Filed: Sep. 7, 2020
(86) PCT No.: PCT/CN2020/113741

§ 371 Date: May 25, 2021

(30) Foreign Application Priority Data
Sep. 9, 2019 (CN) 201910849859.2
Dec. 19, 2019 (CN) PCT/CN2019/126648

(51) Int. Cl. G06T 11/60; G06T 3/00; G06T 11/20

(52) U.S. Cl. CPC G06T 11/60; G06T 11/203; G06T 3/0075

(57) ABSTRACT

The present disclosure discloses a method and device of dynamic processing of an image and a computer-readable storage medium. Based on the position data of the critical points in the original image and the target image, by unit splitting and affine transformation, the mapping relation between any two neighboring states of the initial state, the intermediate states and the ending state is determined, in turn the intermediate images formed in the intermediate states are determined and obtained based on the mapping relation and the correspondence of all of the points in the basic units, and finally the original image, the intermediate images and the target image are sequentially displayed to present a dynamic effect of the images.

### CROSS REFERENCE TO RELEVANT APPLICATIONS

The present application claims the priority of the Chinese patent application CN201910849859.2 filed on Sep. 9, 2019 and the PCT international application PCT/CN2019/126648 filed on Dec. 19, 2019, the disclosure of which is incorporated herein in their entirety by reference.

### TECHNICAL FIELD

The present disclosure relates to a method and device of dynamic processing of an image and a computer-readable storage medium.

### BACKGROUND

Currently, various types of images may serve as the source data of exhibition in products or services such as supermarket retailing, event promotion and digital galleries. During the exhibition, the users may desire to vitalize the exhibition effect by exhibiting dynamic images. However, in the prior art, in the dynamic processing to a certain original image, it is required to use another image as a reference image, and perform the dynamic processing to the original image based on the reference image, which has a tedious operation, and cannot realize the dynamization of a single one image.

### SUMMARY

A first aspect of the embodiments of the present disclosure provides a method of dynamic processing of an image, comprising: acquiring critical points, and determining position data of the critical points in an original image and a target image, wherein the original image refers to an image that is in an initial state and to be dynamically processed, and the target image refers to an image that is obtained after the original image has been dynamically processed and is in an ending state; according to the position data of the critical points in the original image and the target image, determining position data of the critical points in each intermediate state of N intermediate states, wherein N is a positive integer; splitting the original image according to the critical points, to obtain at least one basic unit; by affine transformation, determining a mapping relation between position data of each of vertexes of each of the basic units in any two neighboring states of the initial state, the intermediate states and the ending state; and based on the mapping relation, according to all of points of each of the basic units, determining sequentially the intermediate images formed in each of the intermediate states.

In an embodiment, the method further comprises: displaying sequentially the original image, the intermediate images and the target image.

In an embodiment, the critical points include fixed points and mobile points, the fixed points are for distinguishing a fixed region and a mobile region, and the mobile points are for marking a movement direction of a point within a mobile region.

In an embodiment, the step of acquiring the critical points comprises: acquiring the critical points marked by a user in the original image and the target image by point touching or line drawing; and/or, determining a fixed region and a mobile region that the user smears in the original image and the target image, and according to boundary lines of the fixed region and the mobile region, determining the critical points.

In an embodiment, the step of, according to the position data of the critical points in the original image and the target image, determining the position data of the critical points in each intermediate state of the N intermediate states comprises: determining a predetermined parameter α, wherein α∈[1/(N+1), 2/(N+1), . . . , N/(N+1)]; and according to a formula iₖ=(1−α)xₖ+αtₖ, determining the position data of the critical points in each intermediate state of the N intermediate states, wherein k is a positive integer, and represents the critical points, xₖ is position data of each of the critical points in the original image, tₖ is position data of each of the critical points in the target image, and iₖ is position data of each of the critical points in each of the intermediate states.

In an embodiment, the step of, by the affine transformation, determining the mapping relation between the position data of each of the vertexes of each of the basic units in any two neighboring states of the initial state, the intermediate states and the ending state comprises: according to position data of each of the vertexes of each of the basic units and position data of each of the vertexes in each of the intermediate states and in corresponding points in the target image, acquiring affine-transformation matrixes between position data of each of the vertexes in any two neighboring states of the initial state, the N intermediate states and the ending state.

In an embodiment, the step of, based on the mapping relation, according to all of the points of each of the basic units, determining sequentially the intermediate images formed in each of the intermediate states comprises: based on the mapping relation, according to pixel values of all of points in each of the basic units, determining sequentially pixel values of all of points in the intermediate images formed in each of the intermediate states.

In an embodiment, a shape of the basic units is one of a triangle, a quadrangle and a pentagon.

A second aspect of the embodiments of the present disclosure provides a device of dynamic processing of an image, comprising: a processor; and a memory, wherein the memory stores a computer program, and the computer program, when executed by the processor, causes the processor to perform operations of:

acquiring critical points, and determining position data of the critical points in an original image and a target image, wherein the original image refers to an image that is in an initial state and to be dynamically processed, and the target image refers to an image that is obtained after the original image has been dynamically processed and is in an ending state; according to the position data of the critical points in the original image and the target image, determining position data of the critical points in each intermediate state of N intermediate states, wherein N is a positive integer; splitting the original image according to the critical points, to obtain at least one basic unit; by affine transformation, determining a mapping relation between position data of each of vertexes of each of the basic units in any two neighboring states of the initial state, the intermediate states and the ending state; and based on the mapping relation, according to all of points of each of the basic units, determining sequentially the intermediate images formed in each of the intermediate states.

In an embodiment, the computer program, when executed by the processor, causes the processor to further perform operation of: displaying sequentially the original image, the intermediate images and the target image.

In an embodiment, the computer program, when executed by the processor, causes the processor to further perform operations of: acquiring the critical points marked by a user in the original image and the target image by point touching or line drawing; and/or, determining a fixed region and a mobile region that the user smears in the original image and the target image, and according to boundary lines of the fixed region and the mobile region, determining the critical points.

In an embodiment, the computer program, when executed by the processor, causes the processor to further perform operations of: determining a predetermined parameter α, wherein α∈[1/(N+1), 2/(N+1), . . . , N/(N+1)]; and according to a formula iₖ=(1−α)xₖ+αtₖ, determining the position data of the critical points in each intermediate state of the N intermediate states, wherein k is a positive integer, and represents the critical points, xₖ is position data of each of the critical points in the original image, tₖ is position data of each of the critical points in the target image, and iₖ is position data of each of the critical points in each of the intermediate states.

In an embodiment, the computer program, when executed by the processor, causes the processor to further perform operation of: according to position data of each of the vertexes of each of the basic units and position data of each of the vertexes in each of the intermediate states and in corresponding points in the target image, acquiring affine-transformation matrixes between position data of each of the vertexes in any two neighboring states of the initial state, the N intermediate states and the ending state.

In an embodiment, the computer program, when executed by the processor, causes the processor to further perform operation of: based on the mapping relation, according to pixel values of all of points in each of the basic units, determining sequentially pixel values of all of points in the intermediate images formed in each of the intermediate states.

A third aspect of the embodiments of the present disclosure further provides a nonvolatile computer-readable storage medium, wherein the computer-readable storage medium stores a computer program, and the computer program, when executed by a processor, causes the processor to implement the method of dynamic processing of an image stated above.

A fourth aspect of the embodiments of the present disclosure further provides a method for converting a static image to a dynamic image, comprising: acquiring the static image; and in response to an operation by a user to the static image, implementing to the static image the method of dynamic processing of an image stated above, to obtain the dynamic image.

In an embodiment, the method further comprises: according to an operation by the user to the static image, determining the critical points.

In an embodiment, the operation by the user to the static image comprises at least one of a smearing touch control, a line-drawing touch control and a clicking touch control.

### BRIEF DESCRIPTION OF THE DRAWINGS

FIG. 1 is a flow chart of the method of dynamic processing of an image according to an embodiment of the present disclosure;

FIG. 2 is a case in which the fixed points are determined by smearing according to an embodiment of the present disclosure;

FIG. 3 is an method for drawing the mobile points according to an embodiment of the present disclosure;

FIG. 4 is another method for drawing the mobile points according to an embodiment of the present disclosure;

FIG. 5 is a schematic structural diagram of an apparatus of dynamic processing of an image according to an embodiment of the present disclosure;

FIG. 6 is another schematic structural diagram of an apparatus of dynamic processing of an image according to an embodiment of the present disclosure;

FIG. 7 is a schematic structural diagram of a device of dynamic processing of an image according to an embodiment of the present disclosure;

FIG. 8 is a schematic diagram of the original image and the marking of the critical points according to an embodiment of the present disclosure;

FIG. 9 is a schematic diagram of the initial state of the original image according to an embodiment of the present disclosure;

FIG. 10 is a schematic diagram of the ending state of the original image according to an embodiment of the present disclosure;

FIG. 11 is a schematic diagram of the splitting result of the initial state according to an embodiment of the present disclosure;

FIG. 12 is a flow chart of the method for converting a static image to a dynamic image according to an embodiment of the present disclosure; and

FIG. 13 is a schematic diagram of the operation interface of converting a static image to a dynamic image according to an embodiment of the present disclosure.

### DETAILED DESCRIPTION

Various solutions and features of the present disclosure are described herein with reference to the drawings.

It should be understood that the embodiments of the present disclosure may have various modifications. Therefore, the description should not be considered as limiting, but merely serve as examples of the embodiments. A person skilled in the art can envisage other modifications within the scope and spirit of the present disclosure.

The drawings, which are contained in the description and form part of the description, illustrate the embodiments of the present disclosure, and are intended to interpret the principle of the present disclosure together with the general description on the present disclosure provided above and the detailed description on the embodiments provided below.

From the description below on the embodiments as non-limiting examples with reference to the drawings, those and other characteristics of the present disclosure will become apparent.

It should also be understood that, although the present disclosure has already been described with reference to some particular examples, a person skilled in the art can definitely implement many other equivalent forms of the present disclosure, all of which have the features of the claims and thus fall within the protection scope defined thereby.

Referring to the drawings, in view of the following detailed description, the above and other aspects, characteristics and advantages of the present disclosure will become more apparent.

The particular embodiments of the present disclosure will be described below with reference to the drawings. However, it should be understood that the embodiments that are disclosed are merely examples of the present disclosure, and they may be implemented in various ways. Well-known and/or repeated functions and structures are not described in detail to avoid obscuring the present disclosure by unnecessary or excessive details. Therefore, the particular structural and functional details disclosed herein are not intended as limiting, but merely serve as the basis of the claims and a representative basis for teaching a person skilled in the art to implement the present disclosure in a diversified manner by using substantially any suitable detailed structures.

The description might use the phrases “in an embodiment”, “in another embodiment”, “in yet another embodiment” or “in other embodiments”, all of which may refer to one or more of the same or different embodiments of the present disclosure.

The purpose of the embodiments of the present disclosure is to provide a method, apparatus and device of dynamic processing of an image and a computer-readable storage medium, to solve the problem in the prior art that dynamic processing of an image cannot be realized without another image as a reference, and the dynamic processing of a single image cannot be performed.

In the embodiments of the present disclosure, based on the position data of the critical points in the original image and the target image, by unit splitting and affine transformation, the mapping relation between any two neighboring states of the initial state, the intermediate states and the ending state is determined, in turn the intermediate images formed in the intermediate states are determined and obtained based on the mapping relation and the correspondence of all of the points in the basic units, and finally the original image, the intermediate images and the target image are sequentially displayed to present a dynamic effect of the images. The entire processing process does not require to introduce another reference image, and uses the original image itself as the reference, to simply and quickly obtain a dynamic result of image processing, which solves the problem in the prior art that the dynamic processing of a single image cannot be performed.

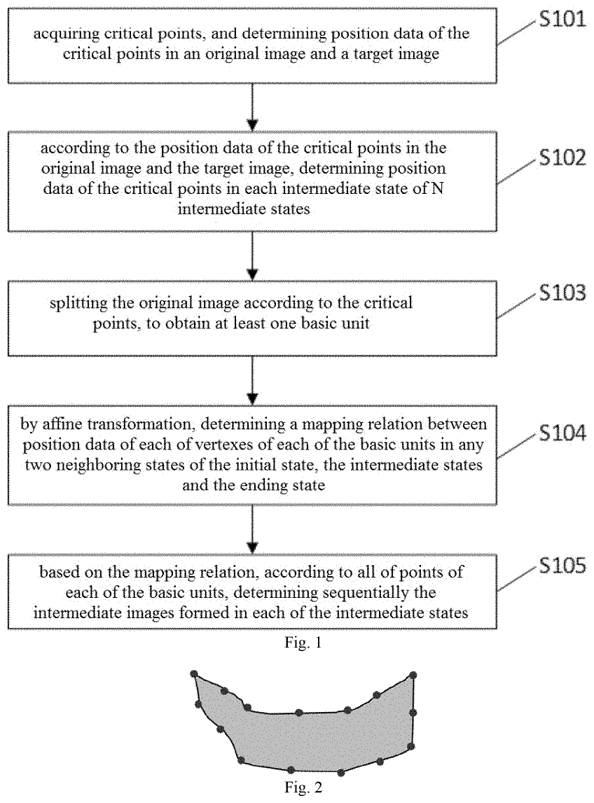

An embodiment of the present disclosure provides a method of dynamic processing of an image, which is mainly applied to an image having a quasi-linear movement mode, such as water flowing and smog diffusion. Its flow chart is shown in FIG. 1, and mainly comprises the steps S101 to S105:

S101: acquiring critical points, and determining position data of the critical points in an original image and a target image.

The original image is the image that is in the initial state and to be dynamically processed, and the target image is the image that is obtained after the original image has been dynamically processed and is in the ending state, i.e., the last one frame of image of the dynamic processing of the original image. The critical points include fixed points and mobile points. The fixed points are used to mark a fixed region in the original image, wherein the points in the fixed region are not dynamically processed. The mobile points are used to represent the points that are required to be dynamically processed in the corresponding region. The positions of the mobile points in the original image are the starting positions, the corresponding positions in the target image are the ending positions of the mobile points after the dynamic processing, and the process of the movement of the mobile points from the starting positions to the ending positions is the process of the dynamic processing according to the present embodiment.

Particularly, all of the quantity, the starting positions and the ending positions of the critical points are set by the user according to practical demands. The acquirement of the critical points may be by directly acquiring the critical points that are marked by point touching or line drawing by the user in the original image and the target image, and may also be by acquiring the fixed region and the mobile region that the user smears in the original image and the target image, and, according to the boundary lines of the fixed region and the mobile region, determining the corresponding critical points. It should be noted that all of the critical points acquired according to the present embodiment are pixel points, i.e., points having defined positions and color numerical values, the color numerical values are the pixel values, and the pixel points having different pixel values correspondingly form images having colors.

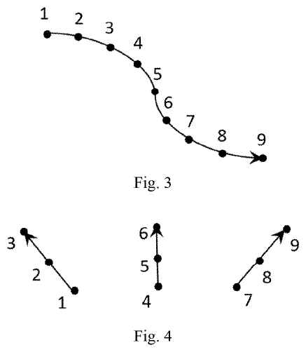

FIG. 2 shows a case in which the fixed points are determined by smearing. In the figure, the region encircled by the black dots is the fixed region smeared by the user in the original image, and accordingly a plurality of points are determined at the boundary lines of the region as the fixed points. Furthermore, because the positions of the fixed points in the original image and the target image are constant, the fixed region does not move. FIG. 3 shows a method of drawing the mobile points. For example, in the simulation of the movement of a river, a line having a direction is drawn to represent the desired movement direction. As shown by the unidirectional arrow in FIG. 3, the point 1 represents the starting point of the drawing, the point 9 represents the ending point of the drawing, and the point 2 to the point 8 represent the process of the movement; in other words, nine mobile points, the point 1 to the point 9, are obtained. Furthermore, in order to realize the effect of flowing in the direction of the arrow, the correspondence relation between the starting positions and the ending positions of the points is set as shown in Table 1.

TABLE 1

| starting position | 1 | 2 | 3 | 4 | 5 | 6 | 7 | 8 |
|---|---|---|---|---|---|---|---|---|
| ending position | 2 | 3 | 4 | 5 | 6 | 7 | 8 | 9 |

By using the ectopic critical points in FIG. 3, the effect of unidirectional movement can be realized. Besides the manner of FIG. 3, the present embodiment may also illustrate the effect of movements in multiple directions by drawing multiple unidirectional arrows, as shown in FIG. 4. In FIG. 4, the point 1, the point 4 and the point 7 serve as the starting points of drawing, the point 3, the point 6 and the point 9 serve as the ending points of drawing, and the point 2, the point 5 and the point 8 represent the process of the movement. At this point, the correspondence relation between the starting positions and the ending positions of the points is shown in Table 2.

TABLE 2

| starting position | 1 | 2 | 4 | 5 | 7 | 8 |
|---|---|---|---|---|---|---|
| ending position | 2 | 3 | 5 | 6 | 8 | 9 |

S102: according to the position data of the critical points in the original image and the target image, determining position data of the critical points in each intermediate state of N intermediate states.

The intermediate states are the transition states that the original image passes through in the transformation process from the initial state to the ending state. In order to realize a good dynamic effect, there are provided N intermediate states, wherein N is a positive integer, preferably 5 to 20. The position data of the critical points in the initial state and the ending state have already been acquired in the step S101, which are usually the coordinate data of the critical points. In order to realize the dynamic effect, the position data of the critical points in the intermediate states should fall upon the movement trajectories of the critical points from the starting positions to the ending positions, and, according to the different intermediate states, the position data corresponding to each of the critical points in the different intermediate states are different.

Particularly, the particular manner of determining the position data of the critical points in the N intermediate states is as follows:

S1021: determining a predetermined parameter α according to the value of N, wherein α∈[1/(N+1), 2/(N+1), . . . , N/(N+1)]; in other words, if N=9, α∈[1/10, 2/10, . . . , 10/10], and in the determination of the position data of the critical points in the first intermediate state, the value of α is set to be 1/10; in the determination of the position data of the critical points in the second intermediate state, the value of α is set to be 2/10; and the rest can be done in the same manner, till the value of α is set to be 9/10, to determine the position data of the critical points in the ninth intermediate state.

S1022: according to a formula iₖ=(1−α)xₖ+αtₖ, determining the position data of the critical points in each intermediate state of the N intermediate states, wherein k is a positive integer, and represents the critical points, xₖ is position data of each of the critical points in the original image, tₖ is position data of each of the critical points in the target image, and iₖ is position data of each of the critical points in each of the intermediate states. The value of α is determined according to which number of the intermediate states is being determined currently. Assuming that the coordinate of one of the critical points in the initial state is (2, 5), the coordinate in the ending state is (8, 7), and in the calculation of the corresponding position data in the fifth intermediate state of the critical point, the value of α is set to be 5/10, i.e., 0.5, then the coordinate corresponding to the critical point is iₖ=(1−0.5)*(2,5)+0.5*(8,7)=(5,6).

S103: splitting the original image according to the predetermined critical points, to obtain at least one basic unit.

In the present embodiment, in order to realize the dynamization of the original image, the actual implementation cannot merely perform dynamic processing to the mobile points, and all of the points in the region formed between the mobile points and the fixed points should be dynamically processed, to in turn in turn form the dynamic effect of some of the regions in the original image. Therefore, it is required to split the original image, to obtain at least one basic unit, and then perform the dynamic processing in the unit of the basic units. Particularly, in the present embodiment, according to the positions of the critical points in the original image, the original image undergoes Delaunay triangulation. The triangular network obtained by the triangulation is unique, and in turn a plurality of basic triangular units are obtained, wherein the vertexes of each of the basic units may be the predetermined critical points, which can prevent the generation of elongate triangles, thereby facilitating the late-stage processing. Certainly, for the splitting of the original image, basic units of another shape may also be used, for example a quadrangle or a pentagon, which is not limited in the present disclosure.

It should be understood that the splitting is performed at the positions of the critical points in the original image, and the critical points have the corresponding position data in all of the intermediate states and the ending state. After the original image has been split, according to the state of the connection between the critical points after the splitting, the critical points in the intermediate states and the ending state are correspondingly connected, to obtain the intermediate units and the target units corresponding to the basic units.

S104: by affine transformation, determining a mapping relation between position data of each of vertexes of each of the basic units in any two neighboring states of the initial state, the intermediate states and the ending state.

In the present embodiment, the states of the movements of all of the points in the original image are determined in the unit of the basic units, and the vertexes of the basic units are the critical points. By affine transformation, the mapping relation between the vertexes of the basic units and the vertexes of the corresponding intermediate units or target units in its neighboring state is correspondingly determined, to represent the mapping relation between all of the points in the basic units and all of the points in the intermediate units or the target units. In other words, the mapping relations between the position data of the vertexes of each of the basic units in any two neighboring states are the same, and the mapping relations correspond to the basic units.

It should be understood that the process of the original image dynamically changing from the initial state to the ending state passes through N intermediate states; in other words, the initial state of the original image and the first intermediate state are referred to as neighboring states, the first intermediate state and the second intermediate state are referred to as neighboring states, the rest can be done in the same manner, the (N−1)-th intermediate state and the N-th intermediate state are referred to as neighboring states, and the N-th intermediate state and the ending state are referred to as neighboring states. In the calculation of the mapping relation, the calculation starts from the mapping relation between the vertexes of the basic units in the initial state and the vertexes of the corresponding intermediate units in the first intermediate state, till the calculation of the mapping relation between the vertexes of the intermediate units in the N-th intermediate state and the vertexes of the corresponding target units in the ending state.

Particularly, in the determination of the mapping relation between the vertexes of the basic units in the initial state and the vertexes of the corresponding intermediate units in the first intermediate state, according to the position data of the vertexes of each of the basic units, and the position data of the vertexes of the corresponding intermediate units in the first intermediate state calculated in the step S102, an affine-transformation matrix is determined, as the relation between the basic units and the corresponding intermediate units, to represent the operations that are performed in the transformation from the basic units to the corresponding intermediate units, such as translation, rotation and zooming. Generally, the affine-transformation matrix is commonly represented by a 2*3 matrix.

S105: based on the mapping relation, according to all of points of each of the basic units, determining sequentially the intermediate images formed in each of the intermediate states.

The present embodiment comprises using the mapping relation determined according to the vertexes of the basic units as the mapping relation of all of the points in the basic units, sequentially determining the positions of the points corresponding to all of the points in the basic units in its neighboring intermediate state, after the positions of the points corresponding to all of the points in the basic units of the original image in its neighboring intermediate state have been calculated out, determining the intermediate image formed in its neighboring intermediate state, and sequentially determining sequentially the intermediate images formed in each of the intermediate states. It should be understood that, for each of the basic units in the original image one mapping relation is determined according to its vertexes, the calculated mapping relations of each of the basic units are different, the mapping relation of each of the basic units is merely applicable to the points in that basic unit, and the mapping relations used by the points that belong to different basic units are different.

Further, the major purpose of determining an intermediate image corresponding to an intermediate state is to determine the pixel values of each of the points in the intermediate state, to form the intermediate image having a color effect, to in turn present a color dynamic effect when the original image, the intermediate images and the target image are being sequentially exhibited. Particularly, both of the original image and the target image are color images whose pixel values are known, and the pixel values of all of the points in the intermediate images are determined according to the pixel values of all of the corresponding points in their corresponding original image. It should be noted that all of the points of the basic units and all of the points in the images according to all of the embodiments of the present disclosure are pixel points, i.e., points having defined positions and color numerical values, the color numerical values are the pixel values, and the pixel points having different pixel values correspondingly form images having colors.

After the pixel values of all of the points of each of the intermediate images have been determined, the original image, the intermediate images and the target image may be sequentially displayed, to enable the region corresponding to the mobile points determined in the original image to present the effect of moving in a certain direction; in other words, the dynamic processing of the original image has been completed.

In the present embodiment, based on the position data of the critical points in the original image and the target image, by unit splitting and affine transformation, the mapping relation between any two neighboring states of the initial state, the intermediate states and the ending state is determined, in turn the intermediate images formed in the intermediate states are determined and obtained based on the mapping relation and the correspondence of all of the points in the basic units, and finally the original image, the intermediate images and the target image are sequentially displayed to present a dynamic effect of the images. The entire processing process does not require to introduce another reference image, and uses the original image itself as the reference, to simply and quickly obtain a dynamic result of image processing, which solves the problem in the prior art that the dynamic processing of a single image cannot be performed.

As an embodiment, in the determination of the mapping relation, besides the method described in the step S104, the method may further comprise, according to the position data of the vertexes of the basic units, determining the first affine-transformation matrix M1 between them and the position data of the vertexes of the corresponding intermediate units in an intermediate state, and, according to the position data of the vertexes of the target units, determining the second affine-transformation matrix M2 between them and the position data of the vertexes of the same corresponding intermediate units in the same intermediate state. Although the contents of the first affine-transformation matrix M1 and the second affine-transformation matrix M2 are different, for a certain point W in the basic units and the point W′ corresponding to it in the target units, the coordinate of the point in the intermediate units calculated according to the first affine-transformation matrix M1 and the coordinate of the point in the intermediate units calculated according to the second affine-transformation matrix M2 are the same, which is W″. The difference is that the pixel values of W″ obtained from the basic units after the mapping are the pixel values of the point W, while the pixel values of W″ obtained from the target units after the mapping are the pixel values of the point W′. Therefore, from the same intermediate state, two images of different pixel values are correspondingly formed. At this point, the method may comprise, according to the formula Z=(1−α)Z₁+αZ₂, calculating to obtain the image formed by the two images of different pixel values by image fusion, and using it as the final intermediate image formed in the intermediate state, wherein Z represents the pixel values of all of the points in the final intermediate image, Z₁ is the pixel values of the image that is obtained correspondingly according to the pixel values of the original image, and Z₂ is the pixel values of the image that is obtained correspondingly according to the pixel values of the target image. The value of α is also related to which number of the intermediate states the intermediate state is, and the different α values, in the fusion, indicate whether the pixel values of the fusion result are closer to the original image or closer to the target image, which in turn enables the different intermediate images to have progressive changing of the pixel values, to enable the original image, the intermediate images and the target image to have a better dynamic effect in the exhibition.

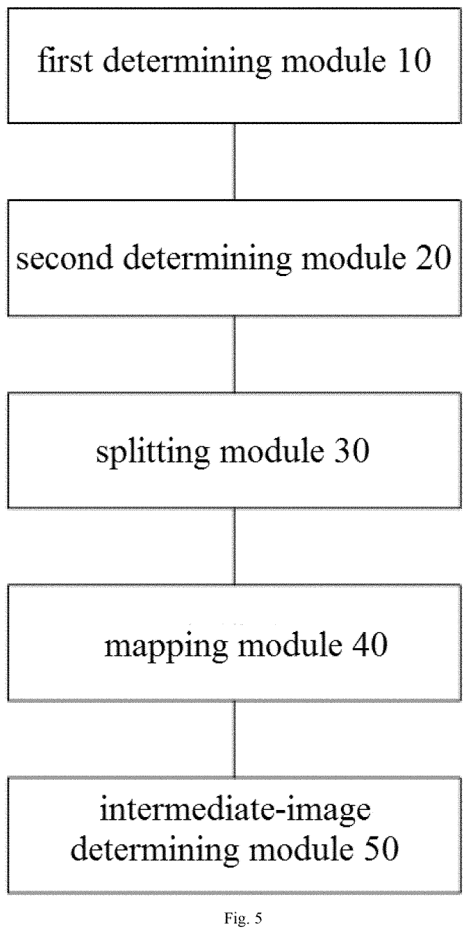

An embodiment of the present disclosure provides an apparatus of dynamic processing of an image, which is mainly applied to an image having a quasi-linear movement mode, such as water flowing and smog diffusion. A schematic structural diagram of the apparatus is shown in FIG. 5, and mainly comprises the following modules that are sequentially coupled: a first determining module 10 configured for acquiring critical points, and determining position data of the critical points in an original image and a target image, wherein the original image refers to an image that is in an initial state and to be dynamically processed, and the target image refers to an image that is obtained after the original image has been dynamically processed and is in an ending state; a second determining module 20 configured for, according to the position data of the critical points in the original image and the target image, determining position data of the critical points in each intermediate state of N intermediate states, wherein N is a positive integer; a splitting module 30 configured for splitting the original image according to the critical points, to obtain at least one basic unit; a mapping module 40 configured for, by affine transformation, determining a mapping relation between position data of each of vertexes of each of the basic units in any two neighboring states of the initial state, the intermediate states and the ending state; and an intermediate-image determining module 50 configured for, based on the mapping relation, according to all of points of each of the basic units, determining sequentially the intermediate images formed in each of the intermediate states.

It should be understood that all of the functional modules described in the present embodiment may be implemented by hardware devices such as a computer, a central processing unit (CPU) and a field programmable gate array (FPGA).

In the present embodiment, the original image is the image that is in the initial state and to be dynamically processed, and the target image is the image that is obtained after the original image has been dynamically processed and is in the ending state, i.e., the last one frame of image of the dynamic processing of the original image. The predetermined critical points include fixed points and mobile points. The fixed points are used to mark a fixed region in the original image, wherein the points in the fixed region are not dynamically processed. The mobile points are used to represent the points that are required to be dynamically processed in the corresponding region. The positions of the mobile points in the original image are the starting positions, the corresponding positions in the target image are the ending positions of the mobile points after the dynamic processing, and the process of the movement of the mobile points from the starting positions to the ending positions is the process of the dynamic processing according to the present embodiment.

Particularly, all of the quantity, the starting positions and the ending positions of the critical points are set by the user according to practical demands. When the first determining module 10 is acquiring the critical points, the acquirement of the critical points may be by directly acquiring the critical points that are marked by point touching or line drawing by the user in the original image and the target image, and may also be by acquiring the fixed region and the mobile region that the user smears in the original image and the target image, and, according to the boundary lines of the fixed region and the mobile region, determining the corresponding critical points. It should be noted that all of the critical points acquired according to the present embodiment are pixel points, i.e., points having defined positions and color numerical values, the color numerical values are the pixel values, and the pixel points having different pixel values correspondingly form images having colors.

The intermediate states are the transition states that the original image passes through in the transformation process from the initial state to the ending state. In order to realize a good dynamic effect, there are provided, for example, N intermediate states, wherein N is a positive integer, preferably 5 to 20. The first determining module 10 has already acquired the position data of the critical points in the initial state and the ending state, which are usually the coordinate data of the critical points. In order to realize the dynamic effect, the position data of the critical points determined by the second determining module 20 in the intermediate states should fall upon the movement trajectories of the critical points from the starting positions to the ending positions, and, according to the different intermediate states, the position data corresponding to each of the critical points in the different intermediate states are different.

Particularly, the second determining module 20 determines the position data of the critical points in the N intermediate states in the following manner:

Firstly, the method comprises determining a predetermined parameter α according to the value of N, wherein α∈[1/(N+1), 2 (N+1), . . . , N/(N+1)]; in other words, if N=9, α∈[1/10, 2/10, . . . , 10/10], and in the determination of the position data of the critical points in the first intermediate state, the value of α is set to be 1/10; in the determination of the position data of the critical points in the second intermediate state, the value of α is set to be 2/10; and the rest can be done in the same manner, till the value of α is set to be 9/10, to determine the position data of the critical points in the ninth intermediate state.

Subsequently, the method comprises, according to a formula iₖ=(1−α)xₖ+αtₖ, determining the position data of the critical points in each intermediate state of the N intermediate states, wherein k is a positive integer, and represents the critical points, xₖ is position data of each of the critical points in the original image, tₖ is position data of each of the critical points in the target image, and iₖ is position data of each of the critical points in each of the intermediate states. The value of α is determined according to which number of the intermediate states is being determined currently.

In the present embodiment, in order to realize the dynamization of the original image, the actual implementation cannot merely perform dynamic processing to the mobile points, and all of the points in the region formed between the mobile points and the fixed points should be dynamically processed, to in turn in turn form the dynamic effect of some of the regions in the original image. Therefore, it is required to split the original image by the splitting module 30, to obtain at least one basic unit, and then perform the dynamic processing in the unit of the basic units. Particularly, the splitting module 30, according to the positions of the critical points in the original image, performs Delaunay triangulation to the original image, the triangular network obtained by the triangulation is unique, and in turn a plurality of basic triangular units are obtained, wherein the vertexes of each of the basic units may be the predetermined critical points, which can prevent the generation of elongate triangles, thereby facilitating the late-stage processing. Certainly, for the splitting of the original image, basic units of another shape may also be used, for example a quadrangle or a pentagon, which is not limited in the present disclosure.

It should be understood that the splitting is performed at the positions of the critical points in the original image, and the critical points have the corresponding position data in all of the intermediate states and the ending state. The splitting module 30, after splitting the original image, according to the state of the connection between the critical points after the splitting, correspondingly connects the critical points in the intermediate states and the ending state, to obtain the intermediate units and the target units corresponding to the basic units.

In the present embodiment, the states of the movements of all of the points in the original image are determined in the unit of the basic units, and the vertexes of the basic units are the critical points. The mapping module 40, by affine transformation, correspondingly determines the mapping relation between the vertexes of the basic units and the vertexes of the corresponding intermediate units or target units in its neighboring state, to represent the mapping relation between all of the points in the basic units and all of the points in the intermediate units or the target units. In other words, the mapping relations between the position data of the vertexes of each of the basic units in any two neighboring states are the same, and the mapping relations correspond to the basic units.

It should be understood that the process of the original image dynamically changing from the initial state to the ending state passes through N intermediate states; in other words, the initial state of the original image and the first intermediate state are referred to as neighboring states, the first intermediate state and the second intermediate state are referred to as neighboring states, the rest can be done in the same manner, the (N−1)-th intermediate state and the N-th intermediate state are referred to as neighboring states, and the N-th intermediate state and the ending state are referred to as neighboring states. In the calculation of the mapping relation by the mapping module 40, the calculation starts from the mapping relation between the vertexes of the basic units in the initial state and the vertexes of the corresponding intermediate units in the first intermediate state, till the calculation of the mapping relation between the vertexes of the intermediate units in the N-th intermediate state and the vertexes of the corresponding target units in the ending state.

Particularly, in the determination of the mapping relation between the vertexes of the basic units in the initial state and the vertexes of the corresponding intermediate units in the first intermediate state by the mapping module 40, according to the position data of the vertexes of each of the basic units, and the position data of the vertexes of the corresponding intermediate units in the first intermediate state calculated by the second determining module 20, an affine-transformation matrix is determined, as the relation between the basic units and the corresponding intermediate units, to represent the operations that are performed in the transformation from the basic units to the corresponding intermediate units, such as translation, rotation and zooming.

The present embodiment comprises using the mapping relation determined according to the vertexes of the basic units as the mapping relation of all of the points in the basic units, sequentially determining the positions of the points corresponding to all of the points in the basic units in its neighboring intermediate state by using the mapping relation by the intermediate-image determining module 50, after the positions of the points corresponding to all of the points in the basic units of the original image in its neighboring intermediate state have been calculated out, determining the intermediate image formed in its neighboring intermediate state, and sequentially determining sequentially the intermediate images formed in each of the intermediate states. It should be understood that, for each of the basic units in the original image one mapping relation is determined according to its vertexes, the calculated mapping relations of each of the basic units are different, the mapping relation of each of the basic units is merely applicable to the points in that basic unit, and the mapping relations used by the points that belong to different basic units are different.

Further, the major purpose of determining an intermediate image corresponding to an intermediate state by the intermediate-image determining module 50 is to determine the pixel values of each of the points in the intermediate state, to form the intermediate image having a color effect, to in turn present a color dynamic effect when the original image, the intermediate images and the target image are being sequentially exhibited. Particularly, both of the original image and the target image are color images whose pixel values are known, and the pixel values of all of the points in the intermediate images are determined according to the pixel values of all of the corresponding points in their corresponding original image.

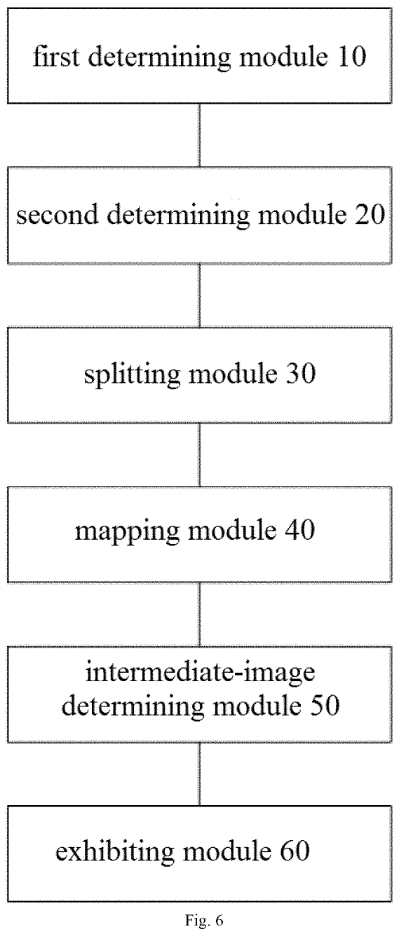

The apparatus of dynamic processing of an image according to the present embodiment may further comprise an exhibiting module 60. As shown in FIG. 6, the exhibiting module 60 is coupled to the intermediate-image determining module 50, and is configured for, after the pixel values of all of the points of each of the intermediate images have been determined, displaying sequentially the original image, the intermediate images and the target image, to enable the region corresponding to the mobile points determined in the original image to present the effect of moving in a certain direction; in other words, the dynamic processing of the original image has been completed.

In the present embodiment, based on the position data of the critical points in the original image and the target image, by unit splitting and affine transformation, the mapping relation between any two neighboring states of the initial state, the intermediate states and the ending state is determined, in turn the intermediate images formed in the intermediate states are determined and obtained based on the mapping relation and the correspondence of all of the points in the basic units, and finally the original image, the intermediate images and the target image are sequentially displayed to present a dynamic effect of the images. The entire processing process does not require to introduce another reference image, and uses the original image itself as the reference, to simply and quickly obtain a dynamic result of image processing, which solves the problem in the prior art that the dynamic processing of a single image cannot be performed.

As an embodiment, in the determination of the mapping relation by the mapping module 40, besides the method disclosed in the above embodiments, the mapping module 40 may further, according to the position data of the vertexes of the basic units, determine the first affine-transformation matrix M1 between them and the position data of the vertexes of the corresponding intermediate units in an intermediate state, and, according to the position data of the vertexes of the target units, determine the second affine-transformation matrix M2 between them and the position data of the vertexes of the same corresponding intermediate units in the same intermediate state. Although the contents of the first affine-transformation matrix M1 and the second affine-transformation matrix M2 are different, for a certain point W in the basic units and the point W′ corresponding to it in the target units, the coordinate of the point in the intermediate units calculated according to the first affine-transformation matrix M1 and the coordinate of the point in the intermediate units calculated according to the second affine-transformation matrix M2 are the same, which is W″. The difference is that the pixel values of W″ obtained from the basic units after the mapping are the pixel values of the point W, while the pixel values of W″ obtained from the target units after the mapping are the pixel values of the point W′. Therefore, from the same intermediate state, two images of different pixel values are correspondingly formed. At this point, the intermediate-image determining module 50, according to the formula Z=(1−α)Z₁+αZ₂, calculates to obtain the image formed by the two images of different pixel values by image fusion, and uses it as the final intermediate image formed in the intermediate state, wherein Z represents the pixel values of all of the points in the final intermediate image, Z₁ is the pixel values of the image that is obtained correspondingly according to the pixel values of the original image, and Z₂ is the pixel values of the image that is obtained correspondingly according to the pixel values of the target image. The value of α is also related to which number of the intermediate states the intermediate state is, and the different α values, in the fusion, indicate whether the pixel values of the fusion result are closer to the original image or closer to the target image, which in turn enables the different intermediate images to have progressive changing of the pixel values, to enable the original image, the intermediate images and the target image to have a better dynamic effect in the exhibition.

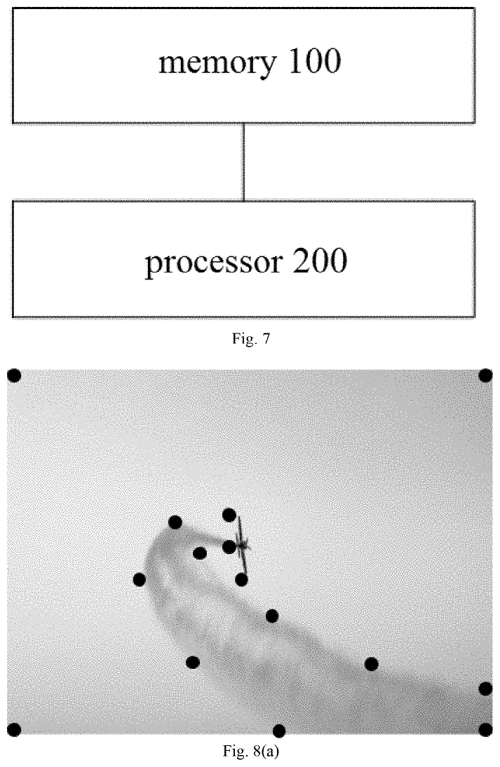

An embodiment of the present disclosure provides a device of dynamic processing of an image. A schematic structural diagram of the device of dynamic processing of an image is shown in FIG. 7, wherein the device comprises at least a memory 100 and a processor 200, the memory 100 stores a computer program, and the processor 200, when executing the computer program in the memory 100, implements the following steps S1 to S5:

S1: acquiring critical points, and determining position data of the critical points in an original image and a target image, wherein the original image refers to an image that is in an initial state and to be dynamically processed, and the target image refers to an image that is obtained after the original image has been dynamically processed and is in an ending state;

S2: according to the position data of the critical points in the original image and the target image, determining position data of the critical points in each intermediate state of N intermediate states, wherein N is a positive integer;

S3: splitting the original image according to the critical points, to obtain at least one basic unit;

S4: by affine transformation, determining a mapping relation between position data of each of vertexes of each of the basic units in any two neighboring states of the initial state, the intermediate states and the ending state; and

S5: based on the mapping relation, according to all of points of each of the basic units, determining sequentially the intermediate images formed in each of the intermediate states.

The processor 200, after implementing the step of, based on the mapping relation, according to all of the points of each of the basic units, determining sequentially the intermediate images formed in each of the intermediate states in the memory 100, further executes the computer program of: displaying sequentially the original image, the intermediate images and the target image.

The processor 200, when implementing the step of acquiring the critical points in the memory 100, particularly executes the computer program of: acquiring the critical points marked by a user in the original image and the target image by point touching or line drawing; and/or, determining a fixed region and a mobile region that the user smears in the original image and the target image, and according to boundary lines of the fixed region and the mobile region, determining the critical points.

The processor 200, when implementing the step of, according to the position data of the predetermined critical points in the original image and the target image, determining the position data of the critical points in each intermediate state of the N intermediate states in the memory 100, particularly executes the computer program of: determining a predetermined parameter α, wherein α∈[1/(N+1), 2/(N+1), . . . , N/(N+1)]; and according to a formula iₖ=(1−α)xₖ+αtₖ, determining the position data of the critical points in each intermediate state of the N intermediate states, wherein k is a positive integer, and represents the critical points, xₖ is position data of each of the critical points in the original image, tₖ is position data of each of the critical points in the target image, and iₖ is position data of each of the critical points in each of the intermediate states.

The processor 200, when implementing the step of, by the affine transformation, determining the mapping relation between the position data of each of the vertexes of each of the basic units in any two neighboring states of the initial state, the intermediate states and the ending state in the memory 100, particularly executes the computer program of: according to position data of each of the vertexes of each of the basic units and position data of each of the vertexes in each of the intermediate states and in corresponding points in the target image, acquiring affine-transformation matrixes between position data of each of the vertexes in any two neighboring states of the initial state, the N intermediate states and the ending state.

The processor 200, when implementing the step of, based on the mapping relation, according to all of the points of each of the basic units, determining sequentially the intermediate images formed in each of the intermediate states in the memory 100, particularly executes the computer program of: based on the mapping relation, according to pixel values of all of points in each of the basic units, determining sequentially pixel values of all of points in the intermediate images formed in each of the intermediate states.

In the present embodiment, based on the position data of the critical points in the original image and the target image, by unit splitting and affine transformation, the mapping relation between any two neighboring states of the initial state, the intermediate states and the ending state is determined, in turn the intermediate images formed in the intermediate states are determined and obtained based on the mapping relation and the correspondence of all of the points in the basic units, and finally the original image, the intermediate images and the target image are sequentially displayed to present a dynamic effect of the images. The entire processing process does not require to introduce another reference image, and uses the original image itself as the reference, to simply and quickly obtain a dynamic result of image processing, which solves the problem in the prior art that the dynamic processing of a single image cannot be performed.

An embodiment of the present disclosure provides a computer-readable storage medium, wherein the computer-readable storage medium stores a computer program, and the computer program, when executed by a processor, implements the method of dynamic processing of an image according to the embodiments of the present disclosure.

The dynamic processing of a single image will be described in detail below with reference to an example.

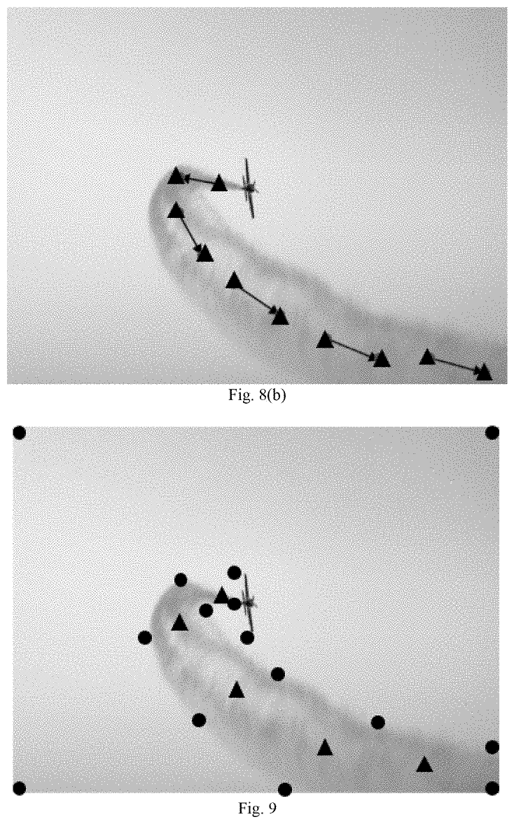

FIGS. 8(a) and 8(b) are the original image that is to be dynamically processed this time, wherein the content of the image displays a jet aircraft and a wake that is left behind in its flight (i.e., the exhaust gas displayed as a stripe in the figures), and it is intended that, after the dynamic processing, the wake in the images presents an effect of flowing.

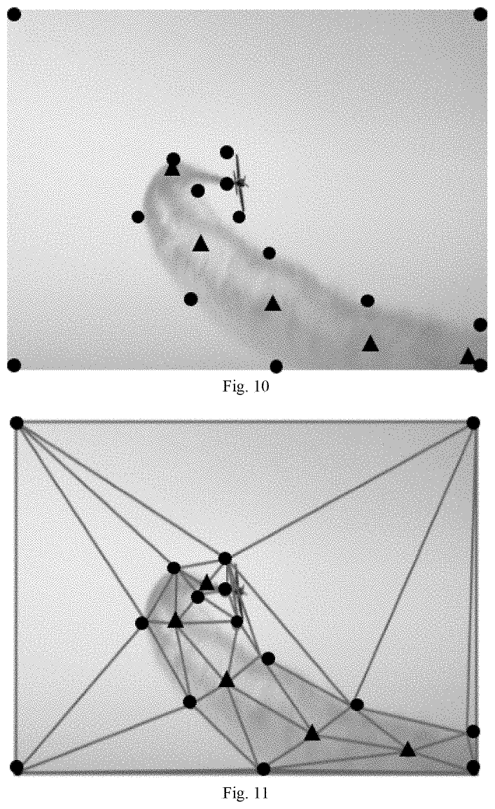

Firstly, the critical points are marked in the figures, for example, marking the four vertexes of the images as the fixed points, to prevent the edges of the whole figures from being destroyed. Subsequently, 3 fixed points around the aircraft are marked, to separate the aircraft in the figures, to ensure that it is not affected. Subsequently, the general region of the wake movement is outlined by using a plurality of fixed points, to ensure that the wake will not go beyond this area in the movement, as shown in FIG. 8(a). Finally, within the area of the wake, according to the current shape of the wake, the direction of the flowing of the air flow is marked by using a plurality of arrows, wherein the starting point of each of the arrows corresponds to the starting position of one mobile point, and the corresponding ending point is the ending position corresponding to the mobile point, as shown in FIG. 8(b). Accordingly, the image formed by the initial positions of the fixed points and the mobile points is the initial state of the original image, as shown in FIG. 9, and the image formed by the ending positions of the fixed points and the mobile points is the ending state of the original image, i.e., the target image, as shown in FIG. 10. It should be noted that all of the solid round dots in FIGS. 8 to 10 correspond to the fixed points, and the mobile points are marked by using solid triangular dots.

After all of the critical points in the two images before and after the transformation have been obtained, according to the quantity of the intermediate images to be split, the value of α is determined, and the position data of all of the critical points in each of the intermediate states are correspondingly determined. In the present embodiment, taking the case in which 9 intermediate images are obtained as an example, i.e., α∈[1/10, 2/10, . . . , 10/10], assuming that a point set of the critical points in the initial state is Pₓ={x₁, x₂, x₃, . . . xₖ, }, and a point set of the critical points in the ending state is Pₜ={t₂, t₃, . . . tₖ, }, wherein k is the serial numbers of the critical points, xₖ is the coordinate value of the k-th critical point in the initial state, and tₖ is the coordinate value of the k-th critical point in the ending state, the corresponding coordinates in the intermediate states of the critical points are obtained by calculating according to the formula iₖ=(1−α)xₖ+αtₖ, to obtain Pᵢ={i₁, i₂, i₃, . . . iₖ,}, wherein iₖ is the coordinate values of the k-th critical point in the intermediate states, and the different intermediate states are distinguished according to the values of α.

After the position data of all of the critical points in each of the intermediate states have been determined, according to the positions of the critical points in the initial state, the initial state is triangulated to obtain a plurality of basic triangles, wherein the result of the splitting is shown in FIG. 11, and, according to the mode of the connection between the critical points in the splitting result of the original image, their corresponding critical points in the intermediate states and the ending state are correspondingly connected, to obtain the intermediate triangles and the target triangles that correspond to the basic triangles.

Subsequently, an affine-transformation matrix as follows is defined:

$$A = {[ \begin{matrix}{a}_{00} & {a}_{01} \\ {a}_{10} & {a}_{11}\end{matrix} ]}_{2 \times 2} , B = {[ \begin{matrix}{b}_{00} \\ {b}_{10}\end{matrix} ]}_{2 \times 1}$$

$$M = [ A B ] = {[ \begin{matrix}{a}_{00} & {a}_{01} & {b}_{00} \\ {a}_{10} & {a}_{11} & {b}_{10}\end{matrix} ]}_{2 \times 3} .$$

The coordinate matrix of the critical points in the initial state is defined as

$$X = [ \begin{matrix}x \\ y\end{matrix} ] ,$$

and the corresponding coordinate matrix of the critical points in the ending state is

$$T = [ \begin{matrix}{x}^{′} \\ {y}^{′}\end{matrix} ] .$$

### Therefore,

$$T = A • [ \begin{matrix}x \\ y\end{matrix} ] + B , i . e . , [ \begin{matrix}{x}^{′} \\ {y}^{′}\end{matrix} ] = [ \begin{matrix}{a}_{00} x + {a}_{01} y + {b}_{00} \\ {a}_{10} x + {a}_{11} y + {b}_{10}\end{matrix} ] .$$

Assuming that the coordinates of the three vertexes of the basic triangles are

$${X}_{1} = [ \begin{matrix}{x}_{1} \\ {y}_{1}\end{matrix} ] , {X}_{2} = [ \begin{matrix}{x}_{2} \\ {y}_{2}\end{matrix} ] and {X}_{3} = [ \begin{matrix}{x}_{3} \\ {y}_{3}\end{matrix} ] ,$$

the coordinates of the three vertexes of the target triangles are

$${T}_{1} = [ \begin{matrix}{x}_{1}^{′} \\ {y}_{1}^{′}\end{matrix} ] , {T}_{2} = [ \begin{matrix}{x}_{2}^{′} \\ {y}_{2}^{′}\end{matrix} ] and {T}_{3} = [ \begin{matrix}{x}_{3}^{′} \\ {y}_{3}^{′}\end{matrix} ] ,$$

and the coordinates of the three vertexes of the intermediate triangles are

$${I}_{1} = [ \begin{matrix}{x}_{1}^{″} \\ {y}_{1}^{″}\end{matrix} ] , {I}_{2} = [ \begin{matrix}{x}_{2}^{″} \\ {y}_{2}^{″}\end{matrix} ]$$

and

$${I}_{3} = [ \begin{matrix}{x}_{3}^{″} \\ {y}_{3}^{″}\end{matrix} ] ,$$

then, for the mapping matrix M1 from the basic triangles to the intermediate triangles,

$$[ \begin{matrix}{x}^{″} \\ {y}^{″}\end{matrix} ] = [ \begin{matrix}{a}_{00} x + {a}_{01} y + {b}_{00} \\ {a}_{10} x + {a}_{11} y + {b}_{10}\end{matrix} ] .$$

After X₁, X₂, X₃, I₁, I₂ and I₃ have been substituted, it is solved to obtain the matrix M1, and in the same manner, the mapping matrix M2 from the target triangles to the intermediate triangles is obtained by calculating according to T₁, T₂, T₃, I₁, I₂ and I₃.

The pixel values of all of the points in the intermediate states in the mapping from the initial state to the intermediate states are calculated according to M1, and the pixel values of all of the points in the intermediate states in the mapping from the ending state to the intermediate states are calculated according to M2. Therefore, the pixel values of the images obtained correspondingly according to the pixel values of the original image and the pixel values of the images obtained correspondingly according to the pixel values of the target image are individually obtained, which are the pixel values of all of the points in the final intermediate image.

The values of α are sequentially changed, to obtain the corresponding intermediate images, till α=1, when the last one intermediate image is obtained. At this point, the original image, the 10 intermediate images and the target image may be sequentially exhibited, to generate a dynamic gif or a video file.

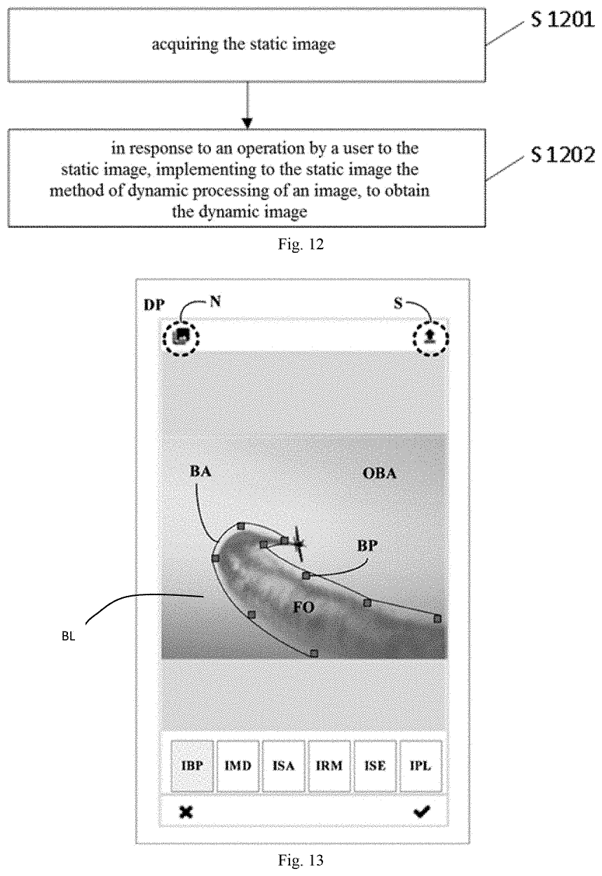

An embodiment of the present disclosure provides a method for converting a static image to a dynamic image. Its flow chart is shown in FIG. 12, and mainly comprises the steps S1201 to S1202:

S1201: acquiring the static image; and

S1202: in response to an operation by a user to the static image, implementing to the static image the method of dynamic processing of an image according to the above embodiments, to obtain the dynamic image.

In an embodiment, the method comprises, according to an operation by the user to the static image, determining the critical points. The operation by the user to the static image comprises at least one of a smearing touch control, a line-drawing touch control and a clicking touch control.

In FIG. 13, the user forms the boundary line BL by line-drawing touch control, and in turn determines a plurality of boundary points BP (i.e., the critical points). In FIG. 8(b), the user forms a plurality of arrows by line-drawing touch control, to determine the movement direction of the dynamic changing, and determines the critical points (i.e., the triangles in FIG. 8(b)) according to the starting points and the ending points of the arrows.

The above embodiments are merely exemplary embodiments of the present disclosure, and are not intended to limit the present disclosure, and the protection scope of the present disclosure is defined by the claims. A person skilled in the art may make various modifications or equivalent substitutions to the present disclosure within the essence and the protection scope of the present disclosure, and such modifications or equivalent substitutions should be considered as also falling within the protection scope of the present disclosure.

1. A method of dynamic processing of an image, comprising:
acquiring critical points, and determining position data of the critical points in an original image and a target image, wherein the original image refers to an image that is in an initial state and to be dynamically processed, and the target image refers to an image that is obtained after the original image has been dynamically processed and is in an ending state;
according to the position data of the critical points in the original image and the target image, determining position data of the critical points in each intermediate state of N intermediate states, wherein N is a positive integer;
splitting the original image according to the critical points, to obtain at least one basic unit;
by affine transformation, determining a mapping relation between position data of each of vertexes of each of the basic units in any two neighboring states of the initial state, the intermediate states and the ending state; and
based on the mapping relation, according to all of points of each of the basic units, determining sequentially the intermediate images formed in each of the intermediate states.

2. The method of dynamic processing of an image according to claim 1, further comprising:
displaying sequentially the original image, the intermediate images and the target image.

3. The method of dynamic processing of an image according to claim 1, wherein the critical points include fixed points and mobile points, the fixed points are for distinguishing a fixed region and a mobile region, and the mobile points are for marking a movement direction of a point within a mobile region.

4. The method of dynamic processing of an image according to claim 1, wherein the step of acquiring the critical points comprises:
acquiring the critical points marked by a user in the original image and the target image by point touching or line drawing; and/or,
determining a fixed region and a mobile region that the user smears in the original image and the target image, and according to boundary lines of the fixed region and the mobile region, determining the critical points.

5. The method of dynamic processing of an image according to claim 1, wherein the step of, according to the position data of the critical points in the original image and the target image, determining the position data of the critical points in each intermediate state of the N intermediate states comprises:
determining a predetermined parameter α, wherein α∈[1/(N+1), 2/(N+1), . . . , N/(N+1)]; and
according to a formula iₖ=(1−α)xₖ+αtₖ, determining the position data of the critical points in each intermediate state of the N intermediate states, wherein k is a positive integer, and represents the critical points, xₖ is position data of each of the critical points in the original image, tₖ is position data of each of the critical points in the target image, and iₖ is position data of each of the critical points in each of the intermediate states.

6. The method of dynamic processing of an image according to claim 1, wherein the step of, by the affine transformation, determining the mapping relation between the position data of each of the vertexes of each of the basic units in any two neighboring states of the initial state, the intermediate states and the ending state comprises:
according to position data of each of the vertexes of each of the basic units and position data of each of the vertexes in each of the intermediate states and in corresponding points in the target image, acquiring affine-transformation matrixes between position data of each of the vertexes in any two neighboring states of the initial state, the N intermediate states and the ending state.

7. The method of dynamic processing of an image according to claim 1, wherein the step of, based on the mapping relation, according to all of the points of each of the basic units, determining sequentially the intermediate images formed in each of the intermediate states comprises:
based on the mapping relation, according to pixel values of all of points in each of the basic units, determining sequentially pixel values of all of points in the intermediate images formed in each of the intermediate states.

8. The method of dynamic processing of an image according to claim 1, wherein a shape of the basic units is one of a triangle, a quadrangle and a pentagon.

9. A device of dynamic processing of an image, comprising:
a processor; and
a memory, wherein the memory stores a computer program, and the computer program, when executed by the processor, causes the processor to perform operations of:
acquiring critical points, and determining position data of the critical points in an original image and a target image, wherein the original image refers to an image that is in an initial state and to be dynamically processed, and the target image refers to an image that is obtained after the original image has been dynamically processed and is in an ending state;
according to the position data of the critical points in the original image and the target image, determining position data of the critical points in each intermediate state of N intermediate states, wherein N is a positive integer;
splitting the original image according to the critical points, to obtain at least one basic unit;
by affine transformation, determining a mapping relation between position data of each of vertexes of each of the basic units in any two neighboring states of the initial state, the intermediate states and the ending state; and
based on the mapping relation, according to all of points of each of the basic units, determining sequentially the intermediate images formed in each of the intermediate states.

10. The device of dynamic processing of an image according to claim 9, wherein the computer program, when executed by the processor, causes the processor to further perform operation of:
displaying sequentially the original image, the intermediate images and the target image.

11. The device of dynamic processing of an image according to claim 9, wherein the computer program, when executed by the processor, causes the processor to further perform operations of:
acquiring the critical points marked by a user in the original image and the target image by point touching or line drawing; and/or,
determining a fixed region and a mobile region that the user smears in the original image and the target image, and according to boundary lines of the fixed region and the mobile region, determining the critical points.

12. The device of dynamic processing of an image according to claim 9, wherein the computer program, when executed by the processor, causes the processor to further perform operations of:
determining a predetermined parameter α, wherein α∈[1/(N+1), 2/(N+1), . . . , N/(N+1)]; and
according to a formula iₖ=(1−α)xₖ+αtₖ, determining the position data of the critical points in each intermediate state of the N intermediate states, wherein k is a positive integer, and represents the critical points, xₖ is position data of each of the critical points in the original image, tₖ is position data of each of the critical points in the target image, and iₖ is position data of each of the critical points in each of the intermediate states.

13. The device of dynamic processing of an image according to claim 9, wherein the computer program, when executed by the processor, causes the processor to further perform operation of:
according to position data of each of the vertexes of each of the basic units and position data of each of the vertexes in each of the intermediate states and in corresponding points in the target image, acquiring affine-transformation matrixes between position data of each of the vertexes in any two neighboring states of the initial state, the N intermediate states and the ending state.

14. The device of dynamic processing of an image according to claim 9, wherein the computer program, when executed by the processor, causes the processor to further perform operation of:
based on the mapping relation, according to pixel values of all of points in each of the basic units, determining sequentially pixel values of all of points in the intermediate images formed in each of the intermediate states.

15. A nonvolatile computer-readable storage medium, wherein the computer-readable storage medium stores a computer program, and the computer program, when executed by a processor, causes the processor to implement the method of dynamic processing of an image according to claim 1.

16. A method for converting a static image to a dynamic image, comprising:
acquiring the static image; and
in response to an operation by a user to the static image, implementing to the static image the method of dynamic processing of an image according to claim 1, to obtain the dynamic image.

17. The method according to claim 16, further comprising:
according to an operation by the user to the static image, determining the critical points.

18. The method according to claim 16, wherein the operation by the user to the static image comprises at least one of a smearing touch control, a line-drawing touch control and a clicking touch control.
